(19) United States
(12) Patent Application Publication
(10) Pub. No.: US 2008/0067009 A1
(43) Pub. Date: Mar. 20, 2008

(54) ELEVATOR BELT FOR AN ELEVATOR INSTALLATION AND METHOD OF PRODUCING SUCH AN ELEVATOR BELT

(76) Inventor: Ernst Ach, Ebikon (CH)

Correspondence Address: FRASER CLEMENS MARTIN & MILLER LLC, 28366 KENSINGTON LANE, PERRYSBURG, OH, 43551, US

(21) Appl. No.: 11/836,490

(22) Filed: Aug. 9, 2007

Related U.S. Application Data
(60) Provisional application No. 60/822,118, filed on Aug. 11, 2006.
(60) Provisional application No. 60/822,123, filed on Aug. 11, 2006.
(60) Provisional application No. 60/822,129, filed on Aug. 11, 2006.
(60) Provisional application No. 60/822,141, filed on Aug. 11, 2006.
(60) Provisional application No. 60/871,872, filed on Dec. 26, 2006.

(30) Foreign Application Priority Data
Aug. 11, 2006 (EP) 06118824.9
Aug. 11, 2006 (EP) 06118816.5
Aug. 11, 2006 (EP) 06118817.3
Aug. 11, 2006 (EP) 06118819.9
Dec. 22, 2006 (EP) 06127121.9

(51) Int. Cl. B66B 7/00; B29D 29/00

(52) U.S. Cl. 187/250; 474/238

(57) ABSTRACT

An elevator belt for an elevator installation includes a wedge rib arrangement with at least two wedge ribs which extend in a longitudinal direction of the elevator belt and form a contact side for engagement with a drive wheel of the elevator installation, a tensile carrier arrangement with at least two tensile carriers arranged in two mutually adjacent wedge ribs of the wedge rib arrangement, and a back layer which forms a rear side, which is opposite the contact side, of the elevator belt. The back layer has a profile with at least one web projecting into the wedge rib arrangement towards the contact side.

### CROSS-REFERENCE TO RELATED APPLICATION

This application claims the benefit of U.S. provisional patent application Ser. No. 60/822,118 filed Aug. 11, 2006, U.S. provisional patent application Ser. No. 60/822,123 filed Aug. 11, 2006, U.S. provisional patent application Ser. No. 60/822,129 filed Aug. 11, 2006, U.S. provisional patent application Ser. No. 60/822,141 filed Aug. 11, 2006, and U.S. provisional patent application Ser. No. 60/871,872 filed Dec. 26, 2006

### FIELD OF THE INVENTION

The present invention relates to an elevator installation with an elevator belt, to an elevator belt for such an elevator installation and to a method of producing such an elevator belt.

### BACKGROUND OF THE INVENTION

An elevator installation comprises an elevator car and usually a counterweight, which are movable in an elevator shaft or along free-standing guide devices. For producing the movement the elevator installation has at least one drive with at least one respective drive wheel, which carries the elevator car and the counterweight by way of one or more elevator belts and/or transmits the required drive forces to these. A drive wheel can in that case be formed in a manner known per se as a drive pulley or equally as a wheel with a smaller diameter, particularly also as a drive output shaft of the drive itself.

The elevator car and the counterweight can be supported and driven by way of the same at least one supporting and drive belt, which is guided over the at least one drive wheel. Alternatively, the elevator car and the counterweight can also be coupled together by way of at least one support belt running over a deflecting roller, so that the counterweight rises when the elevator car is lowered and conversely, wherein the drive of the elevator car and the counterweight takes place by a drive unit via at least one separate drive belt. Whereas in drive belts tension forces are transmitted to these belts by drive wheels in order to move the elevator car or the counterweight, pure support belts are deflected not over drive wheels, but merely over deflecting elements, particularly rotatable or fixed deflecting rollers, and accept the weight force of the elevator car or the counterweight. In most elevator installations the supporting function and driving function are fulfilled by the same at least one supporting and drive belt.

An elevator belt according to the present invention can be used for each of the above-described functions, thus equally as a supporting belt, as a drive belt or as a supporting and drive belt, as well as one of several belts arranged in parallel or as an individual belt.

Where no distinction is required between drive wheels and deflecting rollers, these are generally termed belt wheels in the following.

An elevator belt with several wedge ribs which extend in longitudinal direction of the elevator belt and form a contact side for engagement with a drive wheel of the elevator installation, wherein two tensile carriers are arranged in each wedge rib, is known from European patent EP 1 555 234 B1. A side opposite the wedge ribs can be provided with an additional back layer.

The belt body forming the wedge ribs and receiving the tensile carriers is, according to EP 1 555 234 B1, produced from an elastomer and transmits the supporting and drive forces from the belt wheels to the tensile carriers. The elastomeric wedge ribs deform under the then arising area pressures which are, in part, high. These alternating deformations disadvantageously reduce the service life of the elevator belt. In addition, they can impair their friction couple between the belt body and the tensile carriers received therein and thus the force transmission to the tensile carriers. Equally, a deformation of a wedge rib impairs the friction couple of this or an adjacent wedge rib with the associated wedge groove in the drive wheel.

### SUMMARY OF THE INVENTION

An object of the present invention is therefore to make available an elevator belt in which a smaller resilient deformation of the wedge ribs occurs.

An elevator belt according to the present invention for an elevator installation comprises a wedge rib arrangement with at least two wedge ribs which extend in longitudinal direction of the elevator belt and form a contact side of the elevator belt for engagement with a drive wheel of the elevator installation. The wedge rib preferably comprises more than two wedge ribs, which are provided for engagement with corresponding wedge grooves in the drive wheel. The entire tension force to be transmitted by the elevator belt can thereby be distributed to several wedge ribs, which allows construction of smaller and thus more flexible wedge ribs and thus deflection around smaller belt wheels.

The elevator belt further comprises a tensile carrier arrangement with at least two tensile carriers which extend in longitudinal direction of the elevator belt and are arranged in two mutually adjacent wedge ribs of the wedge rib arrangement. In a preferred embodiment at least one tensile carrier, preferably two or more tensile carriers, is or are arranged in each wedge rib, so that the total tensile force to be transmitted can be distributed to numerous tensile carriers, which can accordingly have a smaller diameter and thus allow deflection around smaller belt wheels. At the same time, individual wedge ribs, which can then be used, for example, as guide ribs, can also be formed to be without tensile carriers. The tensile carriers of the tensile carrier arrangement preferably comprise strands or cables of singly or multiply stranded wires and/or synthetic material threads.

According to the present invention the elevator belt comprises a back layer which forms the rear side of the elevator belt and which has a profile with at least one web, preferably several webs, which protrudes or protrude into the wedge rib arrangement towards the contact side and preferably extends or extend in longitudinal direction of the elevator belt. The wedge rib arrangement is thus supported in transverse direction of the belt in mechanically positive manner at the webs projecting into it, so that the wedge ribs can no longer deform unhindered in this direction. This reduction of the deformations occurring in operation increases the service life of the elevator belt.

Due to the support of the wedge rib arrangement at the web the wedge ribs are stiffened at least in a lower base region remote from the contact side. Advantageously higher area pressures between the drive wheel and the elevator belt looping around this can thereby also be realized, which can improve the friction couple and thus the drive capability.

In addition, in an elevator belt according to the present invention locally higher loads which, for example, due to production or mounting tolerances, contamination or a defect act on a wedge rib advantageously no longer propagate unhindered as shear or pressure stresses to adjacent wedge ribs. It is thereby possible to protect adjacent wedge ribs from such high loads, which can increase the safety of the entire elevator belt against failure.

A further advantage of the present invention can consist in that the contact surface between the wedge rib arrangement and the back layer is enlarged, which improves the interconnection thereof. Also contributing thereto is the mechanically positive couple which comprises a back layer, which is constructed with one or more webs, with the wedge rib arrangement. Forces acting, in particular, in transverse direction on the wedge rib arrangement are supported partly in mechanically positively coupled manner by way of the webs so that shear stresses arising in the wedge rib arrangement and deformations connected therewith, particularly a shearing or transverse expansion of the wedge rib arrangement, can be reduced.

Advantageously an elevator belt according to the present invention can have different materials, which can be respectively matched to the different requirements, on its two sides. Thus, for the back layer a material can be selected which enables a stable support of the wedge ribs and moreover has sufficient flexibility so that the back layer as part of the elevator belt can be deflected around a belt wheel. For the wedge rib arrangement selection can be made of a material which is particularly suitable for transmission of tension forces from the drive wheel to the tensile carriers. Here, in particular, preference is to be given to a material which builds up sufficient adhesion relative to the embedded tensile carriers, has a desired traction capability in conjunction with a drive wheel and at the same time withstands the stresses and deformations occurring in force transmission.

The back layer is therefore preferably produced from a thermoplastic synthetic material, particularly from polyamide (PA), polyethylene (PE), polyester, particularly polyethyleneterephthalate (PET), polycarbonate (PC), polypropylene (PP), polybutyleneterephthalate (PBT), polyethersulfone (PES), polytetrafluorethylene (PTFE), polyvinylchloride (PVC) or polyblend (mixture of two or more different synthetic materials) and/or a fabric of such a thermoplastic synthetic material. The fabric can be embedded in a further one of these thermoplastic synthetic materials or saturated by this.

Such a back layer is on the one hand sufficiently stiff in order to support the wedge rib arrangement. At the same time, it can form a wear-resistant and low-friction rear side of the elevator belt, which is of particular advantage when this loops around deflecting wheels by its rear side. With particular preference the rear side of the elevator belt together with a deflecting wheel therefore has a coefficient of friction of most 0.35, preferably at most 0.3 and particularly preferably at most 0.25. For this purpose the back layer can additionally have on its rear side remote from the contact side a wear-resistant and/or low-friction coating which increases the service life or the efficiency of an elevator belt according to the present invention.

The wedge ribs are preferably made of an elastomer, particularly polyurethane (PU), polychloroprene (CR) or ethylene-propylene-diene rubber (EPDM). Such an elastomer on the one hand allows high area pressures and a good connection with the tensile carriers arranged therein. On the other hand, it can be sufficiently stiffened by the webs projecting in accordance with the invention into the wedge rib arrangement, so that it is not impermissibly deformed, particularly in transverse direction of the elevator belt.

Wedge ribs of such an elastomer preferably have a good friction couple with the drive wheel. For this purpose they can have on the contact side a coating which further increases the coefficient of friction and thus the driving capability. At the same time, the coating can also have a lower coefficient of friction if due to the wedge effect of the wedge ribs a sufficiently high driving capability is already guaranteed. Jamming of the wedge ribs in the wedge grooves of the drive wheel can thereby be avoided. Such a friction-reducing coating can, in addition, increase the wear resistance and thus the service life of the elevator belt. The coefficient of friction between wedge ribs and drive wheel is preferably at most 0.35, preferably at most 0.3 and particularly preferably at most 0.25.

One or more intermediate layers can be arranged between the wedge rib arrangement and the back layer. Such an intermediate layer can, for example, improve the connection between wedge rib arrangement and back layer. Additionally or alternatively an intermediate layer can stiffen the elevator belt in its longitudinal and/or transverse direction or damp oscillations of the elevator belt. For these purposes an intermediate layer can comprise, in particular, a fabric.

A web is advantageously arranged between two mutually adjacent wedge ribs of the wedge rib arrangement. On the one hand the force flow between the wedge rib and the tensile carriers embedded therein is thereby not disturbed. On the other hand, the adjacent wedge ribs are thus at least partly decoupled from one another so that higher loads acting on one of the two wedge ribs do not continue unhindered as shear and/or pressure stresses into the other wedge rib. Thus, in particular, compensation can also be provided for, in particular, the disadvantages of a different load distribution to the individual wedge ribs. Thus, for example, higher tension forces can be transmitted by way of wedge ribs containing several tensile carriers without these higher loads being transmitted to adjacent wedge ribs with fewer tensile carriers.

In particular, pure guide ribs without tensile carriers can thus be relieved of load.

If the wedge rib arrangement comprises more than two wedge ribs, then webs of the back layer are preferably formed between all adjacent wedge ribs, which reduces the deformation of the individual wedge ribs. Additionally or alternatively, webs of the back layer can also be formed on the belt outer side near the outermost wedge ribs. These support the entire wedge rib arrangement in belt transverse direction.

A further advantage of an elevator belt according to the present invention in which the webs project between adjacent wedge ribs into the wedge rib arrangement resides in the fact that the tensile carriers during the production process can be automatically positioned correct in location by the webs. Thus, the tensile carriers during production can be laid in the intermediate spaces between adjacent webs of the back layer and subsequently enclosed by the wedge rib material without being able to migrate into regions of adjacent wedge ribs or into regions of the wedge groove bases formed between the wedge ribs. It is thus possible to use, apart from low-torsion tensile carriers, also tensile carriers which tend to twist in the transverse direction of the belt due to, for example, the stranding.

With particular preference the webs are arranged at or in the vicinity of the deepest place of a wedge groove base lying between adjacent wedge ribs. It is thus possible to prevent tensile carriers placing themselves during the production process in a region of the wedge rib arrangement with small wall thickness where the material stresses, which occur during transmission of the forces from the tensile carriers to the belt wheels, could lead to failure of the wedge rib material. The webs additionally maintain a minimum spacing between adjacent tensile carriers of adjacent wedge ribs. In order to ensure the stated functions it is advantageous if the webs have a certain minimum height in order to prevent, during the production process, migration of the tensile carriers into adjacent wedge ribs. Such a minimum height can be, for example, at least 25%, preferably at least 50% and particularly preferably at least 75%, of the height of the tensile carriers.

Webs are particularly preferred which have a triangular or rectangular cross-section. Back layers with such web cross-sections are particularly simple to produce, for example by extrusion. Rectangular web cross-sections have the advantage that they guide the tensile carriers particularly satisfactorily during the production process of the elevator belt and that they particularly satisfactorily accept transverse forces, which arise in elevator operation, in the web arrangement.

Two mutually adjacent wedge ribs of the wedge rib arrangement can be integrally connected together, wherein they engage over a web, which projects between them into the wedge rib arrangement, of the back layer. The wedge rib arrangement thus forms a continuous contact side and an enlargement of the contact area between web and wedge rib arrangement and thus a good connection between the wedge rib arrangement and the back side are achieved. Through the ratio of web height to height of the adjacent wedge ribs the transmission of stresses within the wedge rib arrangement as well as the deformation occurring in a wedge rib can be influenced in order to produce a uniform loading of the elevator belt.

Alternatively, two mutually adjacent wedge ribs of the wedge rib arrangement can be completely separated from one another by a continuous groove into which the web projects. This enables maximum force and deformation decoupling of these two wedge ribs. In particular, it is thus also achieved that the wedge ribs can be produced from different material. The two forms of embodiment can also be combined with one another, wherein a wedge rib is completely separated by a continuous groove from its wedge rib adjacent on one side and is integrally connected with its wedge rib adjacent on the other side.

In the production of an elevator belt according to the present invention the wedge rib arrangement can be connected with the back layer by means of continuous extrusion, wherein also the tensile carriers are continuously embedded in the wedge rib arrangement. In order to optimize the strength of the connection between the wedge rib arrangement and the back layer the back layer can be previously treated with an adhesion promoter, for example a thermally activatable adhesive. Extruding of the elevator belt forms a particularly rational production process, wherein the wedge rib arrangement and the back layer firmly and permanently connect. The back layer together with its webs can in that case serve as part of a mould for primary forming of the wedge ribs.

The wedge ribs preferably have a flank angle of 60° to 120°, wherein the region from 80° to 100° is to be particularly preferred. The angle between two side surfaces (flanks) of a wedge rib is termed flank angle. This region has proved to be an ideal region in which on the one hand jamming of the wedge ribs in the wedge grooves of the drive wheel and thus transverse oscillations in the elevator belt are avoided and on the other hand a secure guidance of the elevator belt on the belt wheels provided with the wedge grooves is guaranteed.

In advantageous manner the back layer can also have one or more wedge ribs on its rear side. It is thus achieved in advantageous manner that the elevator belt is also guided during rotation of belt wheels on which it rests by its rear side. The number of wedge ribs on the back layer in that case does not have to correspond with the number of wedge ribs of the wedge rib arrangement.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 shows a cross-section through an elevator belt according to a first embodiment of the present invention;

FIG. 2 shows a cross-section through an elevator belt according to a second embodiment of the present invention; and

FIG. 3 shows a section, which is parallel to an elevator car front, through an elevator installation with an elevator belt according to an embodiment of the present invention.

### DESCRIPTION OF THE PREFERRED EMBODIMENT

The U.S. provisional patent application Ser. No. 60/822,118 filed Aug. 11, 2006, the U.S. provisional patent application Ser. No. 60/822,123 filed Aug. 11, 2006, the U.S. provisional patent application Ser. No. 60/822,129 filed Aug. 11, 2006, the U.S. provisional patent application Ser. No. 60/822,141 filed Aug. 11, 2006, and the U.S. provisional patent application Ser. No. 60/871,872 filed Dec. 26, 2006 are hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

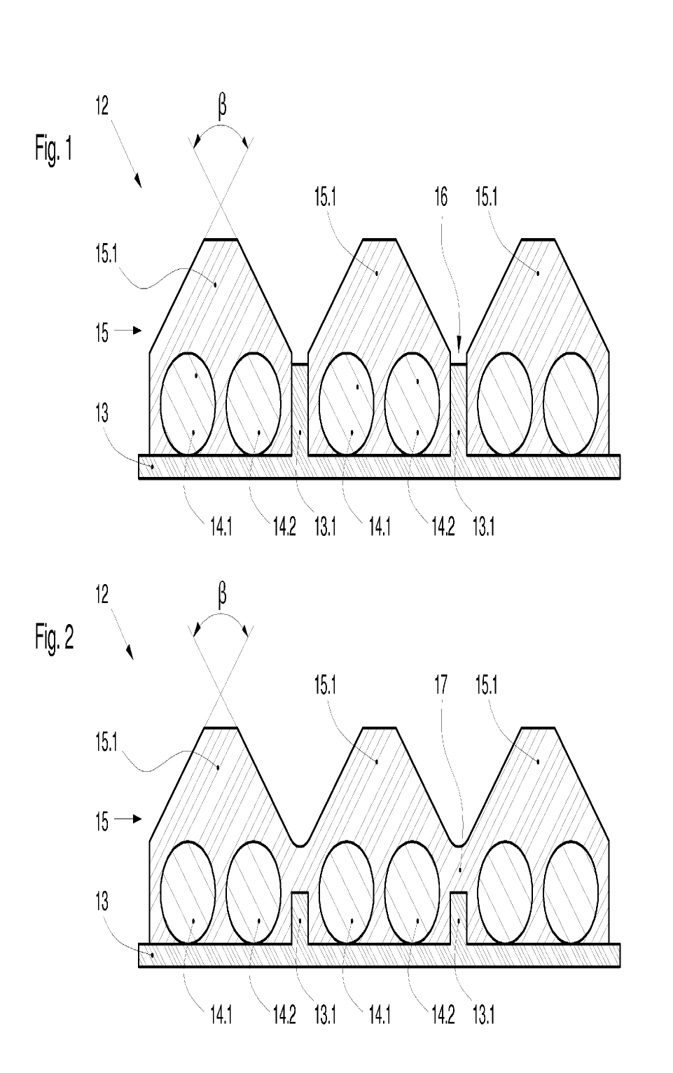

FIG. 1 shows an elevator belt 12 according to a first embodiment of the present invention. This comprises a web rib arrangement 15 with individual wedge ribs 15.1 of polyurethane and a back layer 13 of polyamide connected therewith.

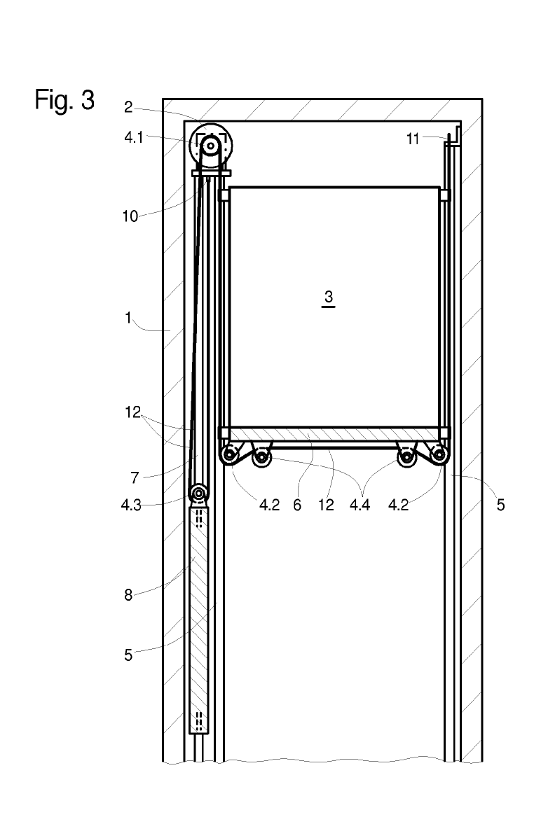

The wedge ribs 15.1 of the wedge rib arrangement 15 have a flank angle β of 120° and form a contact side (at the top in FIG. 1) of the elevator belt 12 for engagement with a drive wheel 4.1 or a deflecting wheel 4.2, 4.3 (see FIG. 3). Insofar as a coefficient of friction different from that given by the polyurethane of the wedge ribs 15.1 is desired the elevator belt can have a coating 17 on its contact side. For example, the flanks of the wedge ribs 15.1 coming into contact with an at least partly complementary wedge groove profile of the drive wheel 4.1 can be coated with a thin polyamide film. In order to facilitate production the entire contact side can at the same time be coated with such a film.

Two tensile carriers 14 are arranged parallel to one another in each wedge rib 15.1 in its base facing the back layer 13. The tensile carriers 14 are formed, in a manner not illustrated in more detail, as wire cables of several wire strands, which in turn are formed from individual single wires of steel stranded together around a synthetic material core.

The back layer 13 has rectangular webs 13.1 which project from the back layer of the elevator belt 12 (at the bottom in FIG. 1) in a direction towards its contact side. A respective web 13.1 is arranged in such a manner between each two adjacent individual wedge ribs 15.1, which are separated from one another by a continuous groove 16 in the longitudinal direction of the elevator belt, that it projects into the groove 16 and extends substantially up to the level of the tensile carriers 14. The webs 13.1 or the grooves 16 are respectively arranged in the region of the deepest place of a wedge groove base between adjacent wedge ribs 15.1.

When the wedge rib arrangement 15 comes into engagement with the substantially complementary wedge groove profile of the drive wheel 4.1 then an area load acts thereon which deforms the individual wedge ribs 15.1. A compression, which is caused by the area load, of the individual wedge ribs 15.1 in a direction towards the rear side of the elevator belt 12 produces a tendency of the wedge ribs to expand in a belt transverse direction (left-to-right in FIG. 1). In addition, shear loads, which can be induced by, for example, an offset between non-aligned drive and deflecting wheels 4.1, 4.2, 4.3 (see FIG. 3), by a twisting of the elevator belt 12 about its longitudinal axis between belt wheels or by rib spacings—which depart from the rib spacings of the wedge rib arrangement 15—of a belt wheel 4.1, 4.2, 4.3, cause a tendency of the individual wedge ribs 15.1 to deform in belt transverse direction.

The webs 13.1 of the back layer 13, at which the individual wedge ribs 15.1 are supported in their base region, counteract such deformations. The back layer 13 as also the webs 13.1 consist of a material (for example polyamide) having a higher stiffness than the elastomeric material (for example polyurethane) of the wedge ribs arrangement 15. Through presetting of the web height the stiffness of the elevator belt 12 in transverse direction can then be influenced. Thus, relatively low webs, which have, for example, at most 30% of the height of the wedge ribs 15.1, allow a more significant deformation of the wedge ribs 15.1 in their regions disposed above the webs 13.1. If, for example, the webs extend to approximately the height of the rectangular base regions of the wedge ribs 15.1 where these base regions go over into trapezium-shaped regions then these base regions can hardly deform, which produces a substantial stiffening of the entire wedge rib arrangement.

The back layer 13 with the webs 13.1 can be produced, for example, by extrusion. In addition, production of an elevator belt 12 according to the first embodiment of the present invention is preferably carried out in an extrusion method. In that case, the back layer 13 as well as two respective tensile carriers 14.1, 14.2 per wedge rib 15.1 of the wedge rib arrangement 15 are fed from rolls correct in position to an extrusion nozzle in an extrusion apparatus, in which the back layer and the tensile carriers are embedded in the hot and thereby viscous elastomeric material of the wedge rib arrangement and the entire elevator belt is formed. The two tensile carriers respectively associated with a wedge rib are in that case embedded in the elastomeric material of the wedge rib arrangement on the upper side, which is remote from the rear side, of the back layer 13 (at the top in FIG. 1) between each two webs 13.1. This material then surrounds the accessible surface of the tensile carriers 14.1, 14.2 and simultaneously connects with the back layer 13 along the surface thereof facing the wedge rib arrangement and not covered by tensile carriers. The connection is created with or without, depending on the respective material combination, a so-termed adhesion promoter which, for example, can be applied to the back layer prior to the extrusion process.

The webs 13.1 formed in the region of the continuous grooves 16 of the wedge rib arrangement 15 advantageously prevent a tensile carrier 14 from displacing, during this production process, into this position where it would be only inadequately integrated in the wedge rib arrangement. In particular, each web 13.1 ensures a minimum spacing of mutually adjacent tensile carriers 14.1, 14.2 of adjacent wedge ribs 15.1. For this purpose it is advantageous if the webs 13.1 have a height corresponding with at least half the height of the tensile carriers 14.1, 14.2.

The back layer 13 forms at its rear side (at the bottom in FIG. 1) remote from the wedge rib arrangement 15 a slide surface which on deflection around a deflecting wheel 4.2 (see FIG. 3) is disposed in contact with the periphery thereof. This slide surface of polyamide has a low coefficient of friction and at the same time a high wear resistance. Advantageously the guidance forces, which are required for lateral guidance of the elevator belt on deflecting wheels, between adjacent flanges of the deflecting wheels and the lateral boundaries of the elevator belt are thus advantageously reduced. The lateral friction loading during deflection of the elevator belt and thus the required drive power of the elevator installation are thereby reduced. At the same time the service life of the elevator belt and the deflecting wheel is prolonged.

FIG. 2 shows an elevator belt 12 according to a second form of embodiment of the present invention. In that case elements corresponding with those of the first form of embodiment are denoted by the same reference numerals so that merely the differences between the first and the second embodiments are discussed in the following.

In the second form of embodiment the wedge ribs 15.1 of the wedge rib arrangement 15 are integrally connected together above the webs 13.1, which here are formed to be shorter, of the back layer 13 and in the region 17 of their wedge groove base engage over the respective web 13.1 which projects between two adjacent tensile carriers 14.1, 14.2 of adjacent ribs 15.1 in the wedge rib arrangement 15 and is enclosed by these on three sides. A continuous contact side of the wedge rib arrangement 15 is thereby formed. Together with the connection of the region 17 of the wedge rib arrangement 15 with the upper side of the webs 13.1 this gives a firmer connection of the wedge rib arrangement 15 with the back layer 13. Moreover, this form of embodiment can be extruded with less problems. Advantageously, in this form of embodiment the web height corresponds with at most half the height of the tensile carriers 14, which has the advantage that the bending stresses arising in the webs are reduced by comparison of those of the first embodiment.

FIG. 3 schematically shows a section through an elevator system, which is installed in an elevator shaft 1, with an elevator belt 12 according to an embodiment of the present invention. The elevator system comprises a drive 2, which is fixed in the elevator shaft 1, with a drive wheel 4.1, an elevator car 3, which is guided at car guide rails 5, with deflecting rollers 4.2 mounted below the car floor 6 and serving as car support rollers, a counterweight 8, which is guided at counterweight guide rails 7, with a further deflecting roller 4.3 serving as counterweight support roller, as well as the elevator belt 12 according to the above-explained first or second embodiment of the invention, which supports the elevator car and the counterweight and transmits thereto the drive force from the drive wheel 4.1 of the drive unit 2.

The elevator belt 12 is fastened to a first belt fixing point 10 at its end below the drive wheel 4.1. From this point it extends downwardly to the deflecting roller 4.3 serving as counterweight support roller, loops around this and extends from this out to the drive wheel 4.1, loops around this and runs downwardly along the car wall at the counterweight side, loops in each instance by 90° around a respective deflecting roller 4.2, which is mounted below the elevator car 3 and serves as car support roller, on either side of the elevator car and runs upwardly along the car wall, which is remote from the counterweight 8, to a second belt fixing point 11.

The plane of the drive wheel 4.1 can be arranged at right angles to the car wall at the counterweight side and its vertical projection can lie outside the vertical projection of the elevator car 3. It is therefore to be preferred that the drive wheel 4.1 has a small diameter so that the spacing between the car wall at the left side and the wall opposite thereto of the elevator shaft 1 can be as small as possible. Moreover, a smaller drive wheel diameter enables use of a gearless drive motor with relatively low drive torque as drive unit 2.

The drive wheel 4.1 and the deflecting roller 4.3 serving as counterweight support roller are provided at the peripheries thereof with wedge grooves which are formed to be substantially complementary with the wedge ribs 15.1 of the elevator belt 12. Where the elevator belt 12 loops around one of the belt wheels 4.1 or 4.3 the wedge ribs 15.1 arranged on its contact side lie in corresponding wedge grooves of the belt wheel, whereby excellent guidance of the elevator belt on these belt wheels is guaranteed. Moreover, the traction capability is improved by a wedge effect arising between the wedge grooves of the belt wheel 4.1, which serves as drive wheel, and the wedge ribs 15.1 of the belt 12.

In the elevator system illustrated in FIG. 3 the looping around of the deflecting rollers 4.2, which serve as car support rollers, below the elevator car 3 takes place in such a manner that the contact side, which has the wedge ribs, of the elevator belt is remote from the periphery of the deflecting rollers 4.2. The elevator belt in that case bears by its back layer against the deflecting rollers 4.2, wherein this back layer, as described in the foregoing, has a low coefficient of friction relative to the deflecting rollers 4.2. In order to guarantee lateral guidance of the elevator belt in this region two additional guide rollers 4.4, which are provided with wedge grooves which co-operate with the wedge grooves of the elevator belt 12 as lateral guide, are mounted at the car floor 6.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator belt for an elevator installation, with a wedge rib arrangement with at least two wedge ribs which extend in a longitudinal direction of the elevator belt and which form a contact side for engagement with a drive wheel of the elevator installation, a tensile carrier arrangement with at least two tensile carriers arranged in two mutually adjacent wedge ribs of the wedge rib arrangement, and a back layer which forms a rear side of the elevator belt, which is opposite the contact side of the elevator belt, comprising: the back layer formed as a flat profile with at least one web projecting into the wedge rib arrangement towards the contact side.

2. The elevator belt according to claim 1 wherein the back layer is produced from a thermoplastic synthetic material including at least one of polyamide, polyethylene, polyester, polyethyleneterephthalate, polycarbonate, polypropylene, polybutyleneterephthalate, polyethersulfone, polytetrafluor-ethylene, polyvinylchloride, a polyblend and a fabric of a thermoplastic synthetic material.

3. The elevator belt according to claim 1 wherein the wedge ribs are produced from an elastomer including at least one of polyurethane, polychloroprene and ethylene-propylene-diene rubber.

4. The elevator belt according to claim 1 wherein the tensile carriers of the tensile carrier arrangement comprise strands or cables of at least one of wires and synthetic material threads.

5. The elevator belt according to claim 4 wherein said strands or cables are singly or multiply stranded.

6. The elevator belt according to claim 1 wherein the wedge ribs of the web ridge arrangement have a coating on the contact side.

7. The elevator belt according to claim 1 including at least one intermediate layer arranged between the wedge rib arrangement and the back layer.

8. The elevator belt according to claim 1 including a web arranged between two mutually adjacent ones of the wedge ribs of the wedge rib arrangement at or adjacent a deepest place of a wedge groove base connecting the two mutually wedge ribs.

9. The elevator belt according to claim 1 wherein two mutually adjacent ones of the wedge ribs of the wedge rib arrangement are integrally connected together.

10. The elevator belt according to claim 1 wherein two mutually adjacent ones of the wedge ribs of the wedge rib arrangement are separated from one another by a continuous groove into which a web of the back layer projects.

11. A method of producing an elevator belt according to claim 1 comprising a step of: connecting the wedge rib arrangement with the back layer by at least one of extrusion and adhesion.

12. An elevator installation with an elevator car, a drive and a belt arrangement with at least one elevator belt according to claim 1 connected to the elevator car and driven by the drive.
